(19) United States
(12) Patent Application Publication
(10) Pub. No.: US 2009/0113102 A1
(43) Pub. Date: Apr. 30, 2009

(54) DETACHABLE EXPANSION DEVICE AND HOST

(75) Inventor: Charles Wang, Shanghai City (CN)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/027,161

(22) Filed: Feb. 6, 2008

(30) Foreign Application Priority Data
Oct. 30, 2007 (CN) 200720182900.8

(51) Int. Cl. G06F 13/00

(52) U.S. Cl. 710/300

(57) ABSTRACT

A host having a casing, a motherboard, and at least a detachable expansion device is provided. The casing has at least an expansion bay. The motherboard is disposed in the casing and has at least a bus expansion portion. The detachable expansion device is detachably disposed in the expansion bay and includes a circuit board, at least a bus connector, a panel, and at least a transmission portion. The bus connector is electrically connected to the circuit board and has a connection port. The panel is connected to a first side of the circuit board and exposes the connection port. A surface of the panel and the connection port are exposed outside the casing. The transmission portion is disposed on the circuit board and electrically connected to the circuit board. The bus connector is electrically connected to the bus expansion portion through the transmission portion.

### CROSS-REFERENCE TO RELATED APPLICATION

This application claims the priority benefit of P.R.C. application serial no. 200720182900.8, filed on Oct. 30, 2007. The entirety of the above-mentioned patent application is hereby incorporated by reference herein and made a part of this specification.

### BACKGROUND OF THE INVENTION

1. Field of Invention

The present invention relates to a detachable expansion device and an electronic apparatus, and more particularly to a detachable expansion device applied to a host and a host using the detachable expansion device.

2. Description of Related Art

With the advancement of technologies, computers have been widely adopted and have become diversified. To enable a user to upgrade the computer or to allow the computer to be equipped with more functions, a motherboard of the computer usually has a bus expansion portion, such as an AGP bus slot, a PCI bus slot, or a universal serial bus (USB) expansion pin set. As regards the bus slot, the user is able to add features to the computer by inserting an interface card (e.g. a graphics card or a network card) into the AGP bus slot or the PCT bus slot installed in the motherboard.

On the other hand, the USB expansion pin set usually includes nine pins and is installed in the motherboard. The USB expansion pin set permits the user to add and install a USB connector. Generally, a plurality of the USB connectors has been configured in the motherboard, so as to connect peripheral devices of the computer, such as a mouse, a printer, a scanner, or an external hard disk. However, due to the diversity of the peripheral devices supporting the computer, the number of the originally-installed USB connectors is no longer sufficient. Hence, efforts to utilize the USB expansion pin set for increasing the number of the USB connectors and for allowing the user to connect related peripheral devices by means of the added USB connectors shall be made.

### SUMMARY OF THE INVENTION

The present invention is directed to a host having a detachable expansion device for increasing the number of bus connectors.

The present invention is further directed to a detachable expansion device adapted to be disposed in a host for increasing the number of bus connectors.

The present invention provides a host having a casing, a motherboard, and at least a detachable expansion device. The casing has at least an expansion bay. The motherboard is disposed in the casing and has at least a bus expansion portion. The detachable expansion device is detachably disposed in the expansion bay and includes a circuit board, at least a bus connector, a panel, and at least a transmission portion. The bus connector is electrically connected to the circuit board and has a connection port. The panel is connected to a first side of the circuit board and exposes the connection port. Besides, a surface of the panel and the connection port are exposed outside the casing. The transmission portion is disposed on the circuit board and electrically connected thereto. The bus connector is electrically connected to the bus expansion portion through the transmission portion.

The present invention further provides a detachable expansion device adapted to be detachably disposed in an expansion bay of a host. The host has a motherboard including at least a bus expansion portion. The detachable expansion device includes a circuit board, at least a bus connector, a panel, and at least a transmission portion. The bus connector is electrically connected to the circuit board and has a connection port. The panel is connected to a first side of the circuit board and exposes the connection port. The transmission portion is disposed on the circuit board and electrically connected to the circuit board. The bus connector is adapted to be electrically connected to the bus expansion portion through the transmission portion.

According to an embodiment of the present invention, the expansion bay is a 3.5-inch drive bay or a 5.25-inch drive bay.

According to an embodiment of the present invention, the bus expansion portion is a USB expansion portion, and the bus connector is a USB connector.

According to an embodiment of the present invention, the bus expansion portion is a serial advanced technology attachment (SATA) bus expansion portion, and the bus connector is a SATA bus connector.

According to an embodiment of the present invention, the bus expansion portion is a 1394 bus expansion portion, and the bus connector is a 1394 bus connector.

According to an embodiment of the present invention, the detachable expansion device further includes a transmission cable electrically connecting the transmission portion and the bus expansion portion.

According to an embodiment of the present invention, the detachable expansion device further includes two side boards respectively connecting a second side of the circuit board and a third side thereof. The first side connects the second and the third sides, and the two side boards face each other.

According to an embodiment of the present invention, the bus expansion portion is an expansion pin set.

The bus connector of the detachable expansion device is electrically connected to the bus expansion portion of the motherboard according to the present invention. Hence, the bus expansion portion of the motherboard can be fully utilized by the detachable expansion device of the present invention, so as to increase the number of the connectors of the host.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional view schematically illustrating a detachable expansion device according to an embodiment of the present invention.

FIG. 2 is a top view schematically illustrating the detachable expansion device of FIG. 1.

FIG. 3 is a three-dimensional view schematically illustrating a host according to an embodiment of the present invention.

FIG. 4 is a side view schematically illustrating the host of FIG. 3.

### DESCRIPTION OF EMBODIMENTS

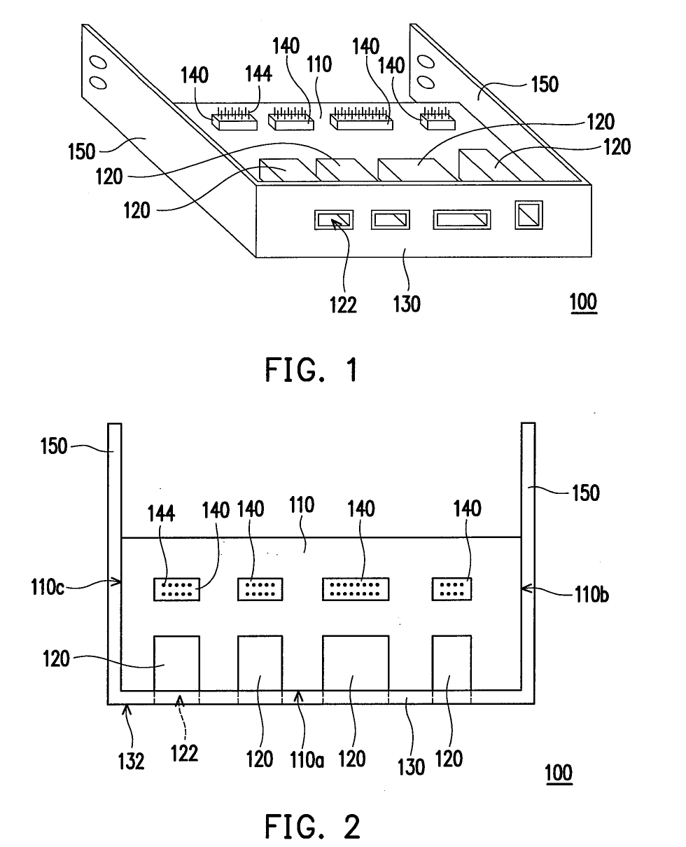

FIG. 1 is a three-dimensional view schematically illustrating a detachable expansion device according to an embodiment of the present invention, while FIG. 2 is a top view schematically illustrating the detachable expansion device of FIG. 1. Referring to FIGS. 1 and 2, a detachable expansion device 100 of the present embodiment includes a circuit board 110, at least a bus connector 120 (four of the bus connectors 120 are schematically illustrated in FIGS. 1 and 2, respectively), a panel 130, and at least a transmission portion 140 (four of the transmission portions 140 are schematically illustrated in FIGS. 1 and 2, respectively). The panel 130 is connected to a first side 110a of the circuit board 110. The bus connectors 120 and the transmission portions 140 are disposed on the circuit board 110 and are electrically connected to the circuit board 110. In addition, each of the bus connectors 120 has a connection port 122 passing through the panel 130, such that the connection ports 122 are exposed by the panel 130. Besides, each of the transmission portions 140 has a plurality of pins 144, and the transmission portions 140 are electrically connected to the bus connectors 120, respectively.

According to the relative positions of the bus connectors 120 illustrated in FIGS. 1 and 2, the four bus connectors 120 are, from left to right in sequence, a USB connector, another USB connector, a SATA bus connector, and a 1394 bus connector, respectively. Note that the bus connectors 120 can be of different types based on actual design requirements, and thus the number of the pins 144 of the corresponding transmission portions can also be changed. For example, the number of the pins 144 of the leftmost transmission portion 140 as shown in FIGS. 1 and 2 may be different from the number of the pins of the rightmost transmission portion 140.

It should be noticed that the USB is a bus standardized by several computer powerhouses, and the USB is used to connect peripheral devices of the computer, such as a printer, a mouse, a keyboard, or an external hard disk. Moreover, the 1394 bus is also a standardized bus. Both the 1394 bus and the USB support a plug-and-play (PNP) installation function. The SATA bus is, by contrast, a hard disk bus newly standardized by a couple of computer powerhouses, and the SATA bus is characterized by serial transmission and high frequency.

In the present embodiment, the circuit board 110 of the detachable expansion device 100 further includes a second side 110b and a third side 110c. The first side 110a of the circuit board 110 connects the second side 110b and the third side 110c. In addition, the detachable expansion device 100 provided in the present embodiment further includes two side boards 150. The second side 110b and the third side 110c respectively connect the side boards 150, and the two side boards 150 face each other.

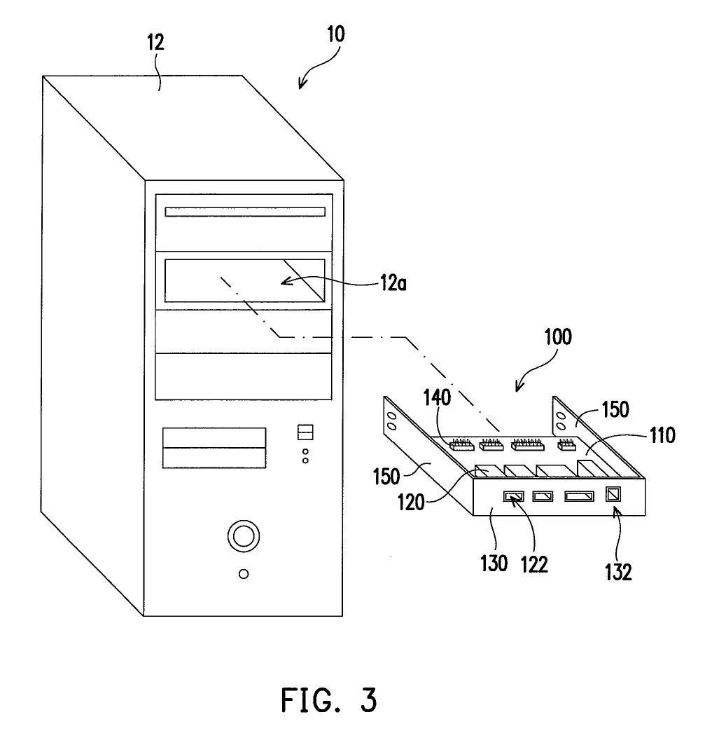

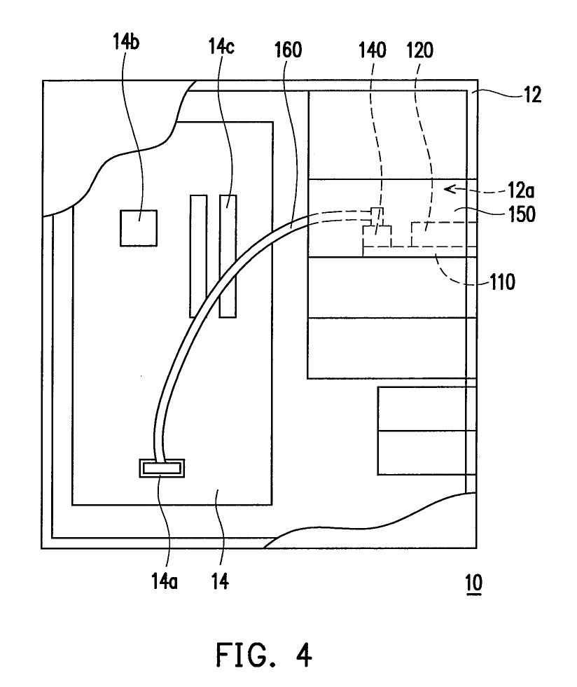

FIG. 3 is a three-dimensional view schematically illustrating a host according to another embodiment of the present invention, while FIG. 4 is a side view schematically illustrating the host of FIG. 3. Note that the detachable expansion device 100 illustrated in FIG. 3 is detached from a host 10, while the detachable expansion device 100 depicted in FIG. 4 is disposed within the host 10. In addition, a cutaway view of a part of the host 10 is illustrated in FIG. 4. Referring to FIGS. 3 and 4, in the present embodiment, the host 10 includes a casing 12, a motherboard 14, and at least one detachable expansion device 100. The casing 12 of the host 10 has at least an expansion bay 12a (six of the expansion bays 12a are schematically illustrated in FIGS. 3 and 4, respectively). Each of the expansion bays 12a is, for example, a 3.5-inch drive bay or a 5.25-inch drive bay. In the present embodiment, four of the expansion bays 12a are 5.25-inch drive bays, while two of the expansion bays 12a are 3.5-inch drive bays. The detachable expansion device 100 is adapted to be disposed in one of the expansion bays 12a.

According to the present embodiment, the detachable expansion device 100 is fixed in one of the expansion bays 12a by means of screws or is locked in one of the expansion bays 12a by means of latches in sliding rails (not shown). In other words, the detachable expansion device 100 is detachably disposed in one of the expansion bays 12a. When the detachable expansion device 100 is disposed in one of the expansion bays 12a, a surface 132 of the panel 130 and the connection ports 122 are exposed outside the casing 12.

The motherboard 14 of the host 10 is disposed in the casing 12 and has at least a bus expansion portion 14a (e.g. the USB expansion portion which can be practiced in a form of the USB expansion pin set), a central processing unit (CPU) 14b, and a random access memory (RAM) 14c. At least one of the bus connectors 120 (e.g. the leftmost bus connector 120 in FIG. 3) of the detachable expansion device 100 is electrically connected to the bus expansion portion 14a through the corresponding transmission portion 140. In detail, the detachable expansion device 100 further includes a transmission cable 160. One end of the transmission cable 160 is electrically connected to one of the transmission portions 140, while the other end of the transmission cable 160 is electrically connected to the bus expansion portion 14a.

It should be noted that another one of the bus connectors 120 of the detachable expansion device 100 is electrically connected to the corresponding bus expansion portion 14a through the corresponding transmission portion 140 and the corresponding transmission cable 160 based on the design demands, given that the motherboard 14 further includes another bus expansion portion 14a (e.g. another USB expansion portion, a SATA bus expansion portion, or a 1394 bus expansion portion). Nevertheless, the above design is not depicted in the drawings.

To sum up, the detachable expansion device and the host applying the same according to the present invention at least have the following advantages:

The bus connector of the detachable expansion device is electrically connected to the bus expansion portion of the motherboard in the present invention. Hence, the bus expansion portion of the motherboard can be fully utilized by the detachable expansion device of the present invention, so as to increase the number of the connectors of the host.

The detachable expansion device of the present invention is disposed in the expansion bay in the casing of the host, and thus the panel of the detachable expansion device is located at a front side of the host. Thereby, the user can easily use the connection port exposed by the panel.

The detachable expansion device of the present invention is disposed in the expansion bay in the casing of the host, and thus the detachable expansion device can take full advantage of the unoccupied space in the casing.

Although the invention has been described with reference to the embodiments thereof, it will be apparent to one of the ordinary skills in the art that modifications to the described embodiments may be made without departing from the spirit of the invention. Accordingly, the scope of the invention will be defined by the attached claims not by the above detailed description.

What is claimed is:

1. A host, comprising:
a casing having at least an expansion bay;
a motherboard disposed in the casing and having at least a bus expansion portion; and
at least a detachable expansion device, detachably disposed in the expansion bay, comprising:
a circuit board;
at least a bus connector electrically connected to the circuit board and having a connection port;
a panel connected to a first side of the circuit board and exposing the connection port, wherein a surface of the panel and the connection port are exposed outside the casing; and
at least a transmission portion disposed on the circuit board and electrically connected with the circuit board, wherein the bus connector is electrically connected with the bus expansion portion through the transmission portion.

2. The host of claim 1, wherein the expansion bay is a 3.5-inch drive bay or a 5.25-inch drive bay.

3. The host of claim 1, wherein the bus expansion portion is a universal serial bus (USB) expansion portion and the bus connector is a USB connector, or the bus expansion portion is a serial advanced technology attachment (SATA) bus expansion portion and the bus connector is a SATA bus connector, or the bus expansion portion is a 1394 bus expansion portion and the bus connector is a 1394 bus connector.

4. The host of claim 1, wherein the detachable expansion device further comprises a transmission cable electrically connecting the transmission portion and the bus expansion portion.

5. The host of claim 1, wherein the detachable expansion device further comprises two side boards respectively connecting a second side of the circuit board and a third side of the circuit board, the first side connects the second and the third sides, and the two side boards face each other.

6. The host of claim 1, wherein the bus expansion portion is an expansion pin set.

7. A detachable expansion device adapted to be detachably disposed in an expansion bay of a host, the host having a motherboard, the motherboard having at least a bus expansion portion, the detachable expansion device comprising:
a circuit board;
at least a bus connector electrically connected with the circuit board and having a connection port;
a panel connected to a first side of the circuit board and exposing the connection port; and
at least a transmission portion disposed on the circuit board and electrically connected to the circuit board, wherein the bus connector is adapted to be electrically connected to the bus expansion portion through the transmission portion.

8. The detachable expansion device of claim 7, wherein the expansion bay is a 3.5-inch drive bay or a 5.25-inch drive bay.

9. The detachable expansion device of claim 7, wherein the bus expansion portion is a USB expansion portion and the bus connector is a USB connector, or the bus expansion portion is a SATA bus expansion portion and the bus connector is a SATA bus connector, or the bus expansion portion is a 1394 bus expansion portion and the bus connector is a 1394 bus connector.

10. The detachable expansion device of claim 7, further comprising a transmission cable electrically connecting with the transmission portion and the bus expansion portion.

11. The detachable expansion device of claim 7, further comprising two side boards respectively connecting with a second side of the circuit board and a third side of the circuit board, the first side connects the second and the third sides, and the two side boards face each other.

12. The detachable expansion device of claim 7, wherein the bus expansion portion is an expansion pin set.
